(19) United States
(12) Patent Application Publication
(10) Pub. No.: US 2012/0123067 A1
(43) Pub. Date: May 17, 2012

(54) BIMODAL POLYETHYLENE PROCESS AND PRODUCTS

(76) Inventors: Sameer D. MEHTA, Mason, OH (US); Mark K. Reinking, Mason, OH (US); Sebastian Joseph, Mason, OH (US); Philip J. Garrison, Houston, TX (US); Everett O. Lewis, Lake Jackson, TX (US); Thomas J. Schwab, Loveland, OH (US); Wallace W. Yau, Pearland, TX (US)

(21) Appl. No.: 13/358,799

(22) Filed: Jan. 26, 2012

Related U.S. Application Data
(62) Division of application No. 12/156,844, filed on Jun. 5, 2008.

(51) Int. Cl. C08F 4/58

(52) U.S. Cl. 526/65

(57) ABSTRACT

Bimodal polyethylene resins having reduced long-chain branching and suitable for use in pipe resin applications as a result of their improved SCG and RCP resistance are provided. The improved resins of the invention are produced in a two-reactor cascade slurry polymerization process using a Ziegler-Natta catalyst system and wherein an alkoxysilane modifier is present in both reactors.

### FIELD OF THE INVENTION

The invention relates to bimodal polyethylene resins having improved properties which render them highly useful for the production of pipes and to a process for their preparation. More specifically, the invention relates to bimodal polyethylene resins which have reduced long-chain branching comprised of a lower molecular weight higher density component and a higher molecular weight lower density component produced in a cascade slurry process.

### BACKGROUND OF THE INVENTION

With the rapid growth of the use of polyethylene pipe, there is increasing emphasis on the development of new polyethylene (PE) resins having improved properties, primarily improved stress cracking resistance, to extend the service-life, i.e., long-term durability, of pipes produced therefrom.

Resistance to stress cracking can be measured in several different ways. Environmental stress crack resistance (ESCR), determined in accordance with ASTM D 1693 typically using either 10 percent or 100 percent Igepal® solution, is widely used but is not a suitable predictive indicator of long-term durability for pipe resins.

A commonly used methodology for long-term predictive performance of pipe resins is the circumferential (hoop) stress test as set forth in ISO 9080 and ISO 1167. Utilizing extrapolation procedures, service life at a given stress and temperature can be predicted and a minimum required strength rating assigned to PE resins.

While the hoop stress test is a good means of determining pressure rating and long-term hydrostatic strength, field experience has shown that pipe failures are often the result of slow crack growth and/or failure caused by sudden impact by a heavy load. As a result, slow crack growth (SCG) resistance and rapid crack propagation (RCP) tests have been developed and are used to differentiate performance of PE pipe resins. SCG resistance is determined using the so-called PENT (Pennsylvania Notched Tensile) test. The latter test was developed by Professor Brown at Pennsylvania University as a small scale laboratory test and has now been adopted as ASTM F 1473-94. RCP is determined on extruded pipe following the procedures of ISO 13477 or ISO 13478 or on a smaller scale using the Charpy Impact Test (ASTM F 2231-02).

PE resin compositions comprised of relatively higher and lower molecular weight components and having a bimodal (BM) molecular weight distribution (MWD) have been used for pipe applications. Such resins, produced using various tandem reactor polymerization processes, have an acceptable balance of strength, stiffness, stress crack resistance and processability as a result of the contributions of the different molecular weight PE species. For a general discussion of bimodal resins and processes see the articles by J. Scheirs, et al., TRIP, Vol. 4, No. 12, pp. 409-415, December 1996 and A. Razavi, Hydrocarbon Engineering, pp. 99-102, September 2004.

EP 1201713 A1 describes a PE pipe resin comprising a blend of high molecular weight PE of density up to 0.928 g/cm³ and high load melt index (HLMI) less than 0.6 g/10 min and lower molecular weight PE having a density of at least 0.969 g/cm³ and MI₂ greater than 100 g/10 min. The resin blends which have a density greater than 0.951 g/cm³ and HLMI from 1-100 g/100 min are preferably produced in multiple reactors using metallocene catalysts.

U.S. Pat. No. 6,252,017 describes a process for copolymerizing ethylene in first and second reactors utilizing chromium-based catalyst systems. Whereas the resins have improved crack resistance they have a monomodal MWD.

U.S. Pat. No. 6,566,450 describes a process wherein multimodal PE resins are produced using a metallocene catalyst in a first reactor to obtain a first PE and combining said first PE with a second PE of lower molecular weight and higher density. Different catalysts may be employed to produce the first and second PEs.

U.S. Pat. No. 6,770,341 discloses bimodal PE molding resins with an overall density of ≧0.948 g/cm³ and MFI_{190/5}≦0.2 g/10 min. obtained from polymerizations carried out in two successive steps using Ziegler-Natta catalysts.

Multi-modal PEs produced by (co)polymerization in at least two steps using Ziegler-Natta catalysts are also disclosed in U.S. Pat. No. 6,878,784. The resins comprised of a low MW homopolymer fraction and a high MW copolymer fraction have densities of 0.930-0.965 g/cm³ and MFR₅ of 0.2-1.2 g/10 min.

U.S. Pat. No. 7,034,092 relates to a process for producing BM PE resins in first and second slurry loop reactors. Metallocene and Ziegler-Natta catalysts are employed and in a preferred mode of operation a relatively high MW copolymer is produced in the first reactor and a relatively low MW homopolymer is produced in the second reactor.

U.S. Pat. Nos. 6,946,521, 7,037,977 and 7,129,296 describe BM PE resins comprising a linear low density component and high density component and processes for their preparation. Preferably the resin compositions are prepared in series reactors using metallocene catalysts and the final resin products have densities of 0.949 g/cm³ and above and HLMIs in the range 1-100 g/10 min.

BM PE resins comprised of low molecular weight (LMW) homopolymer and high molecular weight (HMW) copolymer and wherein one or both components have specified MWDs and other characteristics are described in U.S. Pat. Nos. 6,787,608 and 7,129,296.

U.S. Pat. No. 7,193,017 discloses BM PE compositions having densities of 0.940 g/cm³ or above comprised of a PE component having a higher weight average MW and a PE component having a lower weight average MW and wherein the ratio of the higher weight average MW to lower weight average MW is 30 or above.

U.S. Pat. No. 7,230,054 discloses resins having improved environmental stress crack resistance comprising a relatively high density LMW PE component and relatively low density HMW PE component and wherein the rheological polydispersity of the high density component exceeds that of the final resin product and the lower density component. The resins can be produced by a variety of methods including processes utilizing two reactors arranged in series or in parallel and using Ziegler-Natta, single-site or late-transition metal catalysts or modified versions thereof. Silane-modified Ziegler-Natta catalysts are used to produce the narrower polydispersity lower density component.

There is a continuing need in the industry for resins that have an improved balance of properties suitable for pipe applications. There is a particular need for bimodal resins which have improved SCG and RCP resistance and for processes for making such resins utilizing Ziegler-Natta catalysts.

### SUMMARY OF THE INVENTION

The present invention relates to bimodal high density PE resins having reduced long-chain branching and to the multi-stage polymerization process for their preparation. More specifically, the process entails polymerizing ethylene in the absence or substantial absence of comonomer in a first reactor in the presence of a high activity solid transition metal-containing catalyst, organoaluminum cocatalyst, hydrogen and alkoxysilane of the formula R*_{4-y} Si (OR*)_{y} where y is 2 or 3 and R* is an alkyl or cycloalkyl group to produce a first polymer; treating polymerizate from the first reactor containing said first polymer to remove substantially all hydrogen and transferring to a second reactor; adding ethylene, a C₄₋₈ α-olefin comonomer and hydrogen to the second reactor and continuing the polymerization to produce a second polymer of relatively lower density and higher molecular weight than that of the first polymer to obtain a bimodal polyethylene resin wherein the weight ratio of first polymer to second polymer is from to 65:35 to 40:60. In a highly useful embodiment of the invention the weight ratio of first polymer to second polymer is from 60:40 to 45:55, the alkoxysilane used is cyclohexylmethyldimethoxysilane and the α-olefin comonomer is butene-1.

The bimodal polyethylene resins having reduced long-chain branching produced by the process of the invention have densities from 0.945 to 0.956 g/cm³, HLMIs from 2 to 20 g/10 min and trefBR indexes from 0.001 to 0.5. Particularly useful bimodal pipe resins obtained by the process of the invention have densities from 0.946 to 0.955 g/cm³, HLMIs from 3 to 16 g/10 min, trefBR indexes from 0.01 to 0.2 and are comprised of a first low molecular weight high density polyethylene component having a density of 0.964 to 0.975 g/cm³ and MI₂ of 50 to 400 g/10 min and a second higher molecular weight lower density ethylene-butene-1 copolymer component.

### DETAILED DESCRIPTION OF THE INVENTION

The bimodal PE resins of the invention are comprised of two relatively narrow MWD PE components identified herein as the first PE component and the second PE component. In general terms and relative to each other, the first PE component is a lower MW, higher density resin and the second PE component is a higher MW, lower density resin. The bimodal resin compositions have reduced long-chain branching (LCB) and, as a result, improved SCG and RCP resistance which render them highly useful for pipe applications.

The bimodal polyethylene pipe resins of the invention are produced using a two-stage cascade polymerization process whereby the first PE resin is produced in a first polymerization zone and the second PE resin is produced in a second polymerization zone. By two-stage cascade process is meant two polymerization reactors are connected in series and resin produced in the first reactor is fed into the second reactor and present during the formation of the second PE resin. As a result, the BM PE resin products are an intimate mixture of the first and second PE resin components. Such two-stage processes are known and described in U.S. Pat. No. 4,357,448 details of which are incorporated herein by reference. The polymerizations are preferably conducted as slurry processes in an inert hydrocarbon diluent; however, gas phase processes or a combination of slurry and gas phase processes can be employed.

As used herein, the terms first reactor, first polymerization zone or first reaction zone refer to the stage where a first relatively low molecular weight high density polyethylene (LMW HDPE) resin is produced and the terms second reactor, second polymerization zone or second reaction zone refer to the stage where ethylene is copolymerized with a comonomer to form a second relatively high molecular weight lower density polyethylene (HMW PE) resin component. Whereas the polyethylene formed in the first reactor is preferably a homopolymer, small amounts of comonomer may be present with the ethylene in the first reactor under certain operating conditions, such as in commercial operations where hydrocarbon recovered during the process, typically at the end of the process, and containing low levels of unreacted/unrecovered comonomer is recycled to the first reactor.

The polymerizations are preferably conducted as slurry processes, that is, they are carried out in an inert hydrocarbon medium/diluent, and utilize conventional Ziegler-type catalyst systems. While it is not necessary, it may be desirable to add additional catalyst and/or cocatalyst to the second reactor and these may be the same or different than employed in the first reactor. In a preferred mode of operation, all of the catalyst and cocatalyst employed for the polymerization are charged to the first reactor and carried through to the second reactor without the addition of any additional catalyst or cocatalyst.

Inert hydrocarbons which can be used for the process include saturated aliphatic hydrocarbons such as hexane, isohexane, heptane, isobutane and mixtures thereof. Hexane is a particularly useful diluent. Catalysts and cocatalysts are typically metered into the reactor dispersed in the same hydrocarbon used as the polymerization medium.

Catalyst systems employed are comprised of a solid transition metal-containing catalyst component and an organoaluminum cocatalyst component. The catalyst component is obtained by reacting a titanium or vanadium halogen-containing compound with a magnesium chloride support or a product obtained by reacting a Grignard reagent with a hydropolysiloxane having the formula

$${R}_{a} {H}_{b} {SiO}_{\frac{4 - a - b}{2}}$$

wherein R represents an alkyl, aryl, aralkyl, alkoxy, or aryloxy group as a monovalent organic group; a is 0, 1 or 2; b is 1, 2 or 3; and a+b≦3; or a silicon compound containing an organic group and hydroxyl group in the presence or absence of an aluminumalkoxide, aluminum alkoxyhalide or a reaction product obtained by reacting the aluminum compound with water.

Organoaluminum cocatalysts correspond to the general formula

AlR′ₙX₃₋ₙ

wherein R′ is a C₁-C₈ hydrocarbon group; X is a halogen or an alkoxy group; and n is 1, 2 or 3 and include, for example, triethylaluminum, tributylaluminum, diethylaluminum chloride, dibutylaluminum chloride, ethylaluminum sesquichloride, diethylaluminum hydride, diethylaluminum ethoxide and the like. Triethylaluminum (TEAL) is a particularly useful cocatalyst.

High activity Ziegler-Natta catalyst systems of the above types which are particularly useful for the process of the invention are known and described in detail in U.S. Pat. Nos. 4,223,118, 4,357,448 and 4,464,518, the contents of which are incorporated herein by reference.

To obtain the bimodal PE resins of the invention having reduced LCB and the improved properties associated therewith, an alkoxysilane modifier is utilized for the polymerizations. Alkoxysilanes useful for the invention correspond to the general formula

R*_{4-y}Si(OR*)_{y}

where y is 2 or 3 and each R* is independently a C₁₋₆ alkyl or cycloalkyl group. Preferably the alkoxysilane modifier is a monoalkyltrialkoxysilane or dialkyldialkoxysilane. Even more preferably R* is a methyl, ethyl, cyclopentyl or cyclohexyl group or combinations thereof. Highly useful alkoxysilanes of this latter type include cyclohexylmethyldimethoxysilane (CMDS) and methyltriethoxysilane (MTEOS) and mixtures thereof. In one particularly useful embodiment of the invention, the alkoxysilane modifier is cyclohexylmethyldimethoxysilane.

For the process of the invention, the alkoxysilane modifier is included with the catalyst and cocatalyst in the first reactor and carried through to the second reactor. While it is not necessary, additional silane modifier may be added to the second reactor. If additional silane modifier is added to the second reactor, it can be the same or different than the alkoxysilane utilized in the first reactor for the formation of the LMW HDPE component.

The presence of the silane modifier in both polymerization reactors favorably influences the LCB characteristics of both resin components and the final product. Additionally, MWDs of both resin components are desirably narrowed and more uniform comonomer incorporation is achieved in the second reactor.

More specifically for the slurry process of the invention and to produce the BM PE resins having reduced LCB and correspondingly improved SCG and RCP resistance, ethylene is polymerized in the first reactor in the absence or substantial absence of comonomer targeting the formation of a LMW HDPE component having a density of 0.964 g/cm³ or above and MI₂ in the range 50 to 400 g/10 min. Target densities and MI₂s of polymer produced in the first reactor more typically range from 0.964 to 0.975 g/cm³ and 100 to 300 g/10 min, respectively. Particularly useful BM PE resins are obtained when the LMW HDPE component has a density in the range 0.966 to 0.975 g/cm³ and MI₂ from 150 to 250 g/10 min. Densities referred to herein are determined in accordance with ASTM D 1505. MI₂ is determined according to ASTM D 1238 at 190° C. with 2.16 kg. load.

Density and MI of the resin produced in the first reactor are monitored during the course of the polymerization and conditions are maintained, i.e., controlled and adjusted as necessary, to achieve the targeted values. In general, however, the temperature in the first reaction zone is in the range 75 to 85° C. and, more preferably, from 78 to 82° C. Catalyst concentrations will range from 0.00005 to 0.001 moles Ti/liter and, more preferably from 0.0001 to 0.0003 moles Ti/liter. Cocatalysts are generally used in amounts from 10 to 100 moles per mole of catalyst. The silane modifier is present from about 5 to 20 ppm based on the total inert hydrocarbon diluent fed to the first reactor and, more preferably, from 10 to 17 ppm. Hydrogen is used to control the molecular weight. The amount of hydrogen used will vary depending on the targeted MI₂; however, molar ratios of hydrogen to ethylene in the vapor space will typically range from 2 to 7 and, more preferably, from 3 to 5.5.

Polymerizate, i.e., polymerization mixture from the first reactor containing the LMW HDPE polymer, is then fed to a second reactor where ethylene and a C₄₋₈ α-olefin are copolymerized in the presence of the LMW HDPE polymer particles to form a HMW PE copolymer and produce the final bimodal polyethylene resin product. Prior to introducing the polymerizate from the first reactor to the second reactor, a portion of the volatile materials are removed. Substantially all of the hydrogen is removed in this step since the concentration of hydrogen required in the second reactor to form the higher molecular weight and lower melt index copolymer is substantially lower than that used in the first reactor. Those skilled in the art will recognize, however, that unreacted ethylene and some hydrocarbon diluent may also be removed with the hydrogen. The polymerization is continued and copolymerization in the second reactor is allowed to proceed so that the final BM product has a composition ratio (CR) of LMW HDPE to HMW PE from 65:35 to 40:60. In a highly useful embodiment of the invention for the production of highly SCG- and RCP-resistant BM pipe resins, the CR is from 60:40 to 45:55 (LMW HDPE:HMW PE). CR ratios referenced herein are on a weight basis.

Reactor conditions in the second reactor will vary from those employed in the first reactor. Temperatures typically are maintained from 68 to 80° C. and, more preferably, from 70 to 79° C. Catalyst, cocatalyst and silane modifier levels in the second reactor will vary based on concentrations employed in the first reactor and whether optional additions are made during the copolymerization.

Comonomer is introduced with additional ethylene into the second reactor. Useful comonomers include C₄₋₈ α-olefins, particularly, butene-1, hexene-1 and octene-1. Particularly useful BM PE pipe resins are obtained when the LMW PE resin is a copolymer of ethylene and butene-1.

Whereas the LMW HDPE resin produced in the first reactor can be readily sampled and density and MI monitored to control reactor conditions in the first reactor, the HMW PE copolymer produced in the second reactor is not available as a separate and distinct product since it is formed in intimate admixture with the LMW HDPE particles. Therefore, while it is possible to calculate the density and HLMI of the HMW PE copolymer using established blending rules, it is more expedient to monitor the density and HLMI of the final resin product and, if necessary, control and adjust conditions within the second reaction zone to achieve the targeted values for the final resin product.

Mole ratios of hydrogen to ethylene in the vapor space and comonomer to ethylene in the vapor space of the second reactor are therefore maintained based on the targeted density and HLMI of the final BM PE resin product. In general, both of these ratios will range from 0.05 to 0.09.

Bimodal PE resins produced in accordance with the above-described two-stage cascade slurry polymerization process utilizing silane-modified Ziegler-Natta catalysts and having CR ratios of LMW HDPE component to HMW PE component within the above-prescribed limits will have densities in the range 0.945 to 0.956 g/cm³ and, more preferably, from 0.946 to 0.955 g/cm³. HLMIs typically range from 2 to 20 g/10 min, and more preferably, are from 3 to 16 g/10 min. In a particularly useful embodiment where the BM PE resins are ethylene-butene-1 copolymer resins, densities preferably range from 0.947 to 0.954 g/cm³ with HLMIs from 4 to 14 g/10 min. HLMIs (sometimes also referred to as MI₂₀) are measured according to ASTM D1238 at 190° C. with a load of 21.6 kg.

The BM PE resins of the invention are further characterized by having significantly reduced LCB compared to BM resins produced by prior art processes. This feature in combination with the physical and rheological properties of the resins renders them highly suitable for the production of extruded pipe having improved SCG and RCP resistance. LCB is quantified utilizing a branching index referred to as trefBR. trefBR is calculated from parameters obtained utilizing a 3D-GPC-TREF system of gel permeation chromatography (GPC) coupled with the capability of temperature rising elution fractionation (TREF) that includes three online detectors, specifically, infrared (IR), differential-pressure viscometer (DP) and light scattering (LS). The equipment and methodologies used are described in articles by W. Yau, et al., Polymer 42 (2001), 8947-8958 and W. Yau, Macromol. Symp., (2007) 257:29-45, details of which are incorporated herein by reference.

The trefBR index is calculated using the equation

$$trefBR = [ \frac{K \cdot {MW}^{α}}{[ η ]} ] - 1$$

where K and α are the Mark-Houwink parameters for polyethylene, 0.00374 and 0.73, respectively; MW is the LS-measured weight average molecular weight; and [η] is the intrinsic viscosity. The calculated trefBR value represents the average LCB level in the bulk sample. Low trefBR values indicate low levels of

LCB. trefBR values of the BM PE resins having improved SCG and RCP properties produced by the process of the invention range from 0.001 to 0.5 and, more preferably, from 0.01 to 0.2. trefBR values reported herein were determined using trichlorobenzene for the polymer that eluted from the column at a temperature of greater than 85° C.

BM resins produced in accordance with the process of the invention and having the above-described characteristics have microstructures which render them highly useful for the production of pipes having improved SGP and RGP resistance. Additionally, the rheological properties of the component resins make it possible to achieve higher densities while retaining processability of the final resin product.

The following examples illustrate the invention more fully. Those skilled in the art will, however, recognize many variations that are within the spirit of the invention and scope of the claims.

In all of the examples which follow the bimodal PE recovered from the second reactor, which was an intimate mixture of LMW HDPE and HMW PE, was dried and the resulting powder sent to a finishing operation where it was compounded with 2000 ppm Ca/Zn stearate and 3200 ppm hindered phenol/phosphite stabilizers and pelletized. Properties reported for the final products were obtained using the finished/pelletized resins.

### EXAMPLE 1

Ethylene, hexane, a high activity titanium catalyst slurry, TEAL cocatalyst, silane modifier and hydrogen were continuously fed into a first polymerization reactor to make a low molecular weight high density polyethylene (LMW HDPE) resin. The silane modifier used was CMDS. The catalyst was prepared in accordance with examples of U.S. Pat. No. 4,464,518 and diluted with hexane to the desired titanium concentration. The silane modifier and TEAL were also fed as hexane solutions. Feed rates and polymerization conditions employed in the first reactor are shown in Table 1. MI₂ and density of the LMW HDPE produced are also listed in Table 1.

A portion of the reaction mixture from the first reactor was continuously transferred to a flash drum where hydrogen, unreacted ethylene and some of the hexane were removed. The hexane slurry recovered from the flash drum containing the LMW HDPE, residual catalyst, residual cocatalyst and residual CMDS in hexane was then transferred to a second reactor to which fresh hexane, ethylene and hydrogen were added along with butene-1 comonomer. Copolymerization conditions employed in the second reactor to produce the higher molecular weight lower density polyethylene (HMW PE) copolymer component are shown in Table 2. No additional catalyst, cocatalyst or silane modifier were added to the second reactor.

The composition ratio, HLMI, density and trefBR index of the final bimodal PE resin product are reported in Table 3.

Rheological characteristics of the BM PE resin product were also evaluated by measuring rheological polydispersity (commonly referred to as “ER”) using complex viscosity as a function of frequency. Rheological measurements were performed in accordance with ASTM 4440-95a, which measures dynamic rheology data in the frequency sweep mode. A Rheometrics ARES rheometer was used, operating at 190° C., in parallel plate mode under nitrogen to minimize sample oxidation. The gap in the parallel plate geometry was typically 1.2-1.4 mm, the plate diameter was 50 mm, and the strain amplitude was 10%. Frequencies ranged from 0.0251 to 398.1 rad/sec.

ER was determined by the method of Shroff et al., J. Applied Polymer Sci. 57 (1995), 1605. Thus, storage modulus (G′) and loss modulus (G″) were measured and the nine lowest frequency points used (five points per frequency decade) to fit a linear equation by least-squares regression to log G′ versus log G″. ER was then calculated from:

ER=(1.781×10⁻³)×G′

at a value of G″=5,000 dyn/cm². Temperature, plate diameter, and frequency range were selected such that, within the resolution of the rheometer, the lowest G″ value was close to or less than 5,000 dyn/cm². The ER of the BM PE resin was 1.70.

Additionally, ER was determined using the above method for the LMW HDPE component and calculated for the HMW PE component in accordance with the procedure of U.S. Pat. No. 7,230,054. ER values for the respective components were 0.80 and 0.60. The fact that the ER of the final BM PE resin obtained by the process of the invention is significantly higher than that of either of the individual resin components is unexpected and illustrates the markedly different results achieved with the process of the invention (where silane modifier is present in both reactors) versus prior art processes (such as described in U.S. Pat. No. 7,230,054) where a silane modifier is optionally used to produce only the higher molecular weight lower density component.

### COMPARATIVE EXAMPLE 2

To demonstrate the significantly different results achieved with the process of the invention, Example 1 was repeated but without using the silane modifier. The comparative run targeted a final resin product having a HLMI and density as close as possible to that provided in Example 1. Feed rates and polymerization conditions employed in the first and second reactors and properties of the LMW HDPE component and final product produced are reported in Tables 1, 2 and 3.

The markedly different LCB characteristics obtained with the comparative bimodal blend at similar MI and density is apparent from a comparison of the trefBR values obtained for the comparative BM resin and the inventive BM resin of Example 1. The different microstructures of the comparative and inventive BM resins, as evidenced by the different trefBR values, and the resultant affect on the SCG and RCP properties is demonstrated by physical testing.

### Resin Testing

The significantly improved performance achieved with the products of the invention is apparent from a comparison of the SCG and RCP resistance of samples produced from the inventive BM PE resin of Example 1 having reduced LCB and the comparative BM PE resin of Comparative Example 2. To evaluate SCG and RCP resistance, test specimens were prepared from the inventive and comparative BM resins and tested using the so-called PENT test (ASTM F 1473-94) and the Charpy impact test ASTM F 2231-02. Test results were as follows:

| | Ex 1 | Comp. Ex 2 |
|---|---|---|
| PENT @ 3.2 Mpa (hrs) | 6677 | 1554 |
| Charpy (kJ/m²) | 51.4 | 32.6 |

The above data clearly demonstrate the significant and unexpected improvement in SCG and RCP resistance obtained with the pipe resins of the invention having reduced LCB.

### Pipe Extrusion

To demonstrate processability, the resin of Example 1 was extruded into 1″ I.D. pipe. The extrusion line consisted of a 2.5 inch single screw extruder with a 24:1 L/D and having 4 heating zones. Screw speed was 23 rpm and the line speed was 4 ft/min. Temperatures in the 4 heating zones and in the die were 410° F., 410° F., 410° F., 400° F. and 380° F., respectively. The head pressure was 1610 psi and melt temperature of the extrudate was 368° F. The extruded pipe had a smooth surface and uniform wall thickness. Average wall thickness of the pipe was 124.25 mils.

TABLE 1

Example

| | 1 | Comp. 2 |
|---|---|---|
| Pressure (psig) | 119 | 119 |
| Temperature (° C.) | 80 | 80 |
| Ethylene (lbs/hr) | 30.2 | 30.2 |
| Hexane (Total) (lbs/hr) | 136 | 139 |
| Catalyst Slurry (moles Ti/hr) | 0.002427 | 0.000886 |
| Cocatalyst (moles/hr) | 0.097 | 0.058 |
| PPM CMDS* | 15 | 0 |
| H₂ (lbs/hr) | 0.110 | 0.116 |
| MI₂ (g/10 min) | 202 | 195 |
| Density (g/cm³) | 0.9717 | 0.9711 |

*based on the total hexane fed to the reactor

TABLE 2

Example

| | 1 | Comp 2 |
|---|---|---|
| Pressure (psig) | 24 | 20 |
| Temperature (° C.) | 76.7 | 76.7 |
| Ethylene (lbs/hr) | 27.9 | 27.9 |
| Butene-1 (lbs/hr) | 2.31 | 1.48 |
| Hexane (Fresh) (lbs/hr) | 186 | 187 |
| Hydrogen (ppm in C2 feed) | 450 | 60 |

TABLE 3

Example

| | 1 | Comp 2 |
|---|---|---|
| CR | 52:48 | 52:48 |
| HLMI (g/10 min) | 5.8 | 5.8 |
| Density (g/cm³) | 0.9498 | 0.9503 |
| trefBR | 0.02 | 0.28 |

### EXAMPLES 3 and 4

Two BM resins were produced following the general procedure of Example 1 except that process conditions were varied to target a density of 0.953 g/cm³ and HLMI of 5.7 g/10 min in the final resin product. The catalyst, cocatalyst and silane modifier were the same as employed for Example 1; however, the composition ratio of Example 4 was different. MI₂ and density of the LMW HDPE component produced in the first reactor for Examples 3 and 4 were 202 g/10 min and 0.9714 g/cm³ and 215 g/10 min and 0.9717 g/cm³, respectively.

HLMI, density and trefBR values for the BM PE resins produced were as follows:

| | Ex 3 | Ex 4 |
|---|---|---|
| CR (LMW HDPE:HMW PE) | 52:48 | 48:52 |
| HLMI (g/10 min) | 5.4 | 6.1 |
| Density (g/cm³) | 0.9527 | 0.9540 |
| trefBR | 0.03 | 0.02 |

Both resins exhibited good processability and were readily extrudable into pipe. Charpy impact values obtained for the resins of Examples 3 and 4 were 50.6 and 50.3 kJ/m², respectively.

### EXAMPLE 5

A bimodal PE resin comprised of LMW HDPE (MI 237 g/10 min; density 0.9717 g/cm³) and HMW PE resin components (CR 52:48) was prepared in accordance with the procedure of Example 1 except that the silane modifier used was methyltriethoxysilane. The targeted final product HLMI and density were 5.7 g/10 min and 0.953 g/cm³, respectively. Properties of the resin obtained were as follows:

| | |
|---|---|
| HLMI (g/10 min) | 5.8 |
| Density (g/cm³) | 0.9530 |
| trefBR | 0.06 |

A test specimen prepared from the BM resin had a Charpy impact value of 42.7 kJ/m².

### EXAMPLE 6

The procedure of Example 1 was repeated except that octene-1 was employed as the comonomer in the second reactor. Conditions were maintained to target a final product having a density of 0.953 g/cm³ and HLMI of 5.7 g/10 min. The BM PE resin product obtained having reduced LCB and comprised of LMW HDPE and HMW PE resin components at a composition ratio of 48:52 had the following properties.

| | |
|---|---|
| HLMI (g/10 min) | 5.6 |
| Density (g/cm³) | 0.9542 |
| trefBR | 0.18 |

The BM resin had a Charpy impact value of 59.9 kJ/m².

1. A process for making a bimodal polyethylene resin comprising:
(a) polymerizing ethylene in the absence or substantial absence of comonomer in a first reactor in the presence of a high activity solid transition metal-containing catalyst, organoaluminum cocatalyst, hydrogen and alkoxysilane to produce a polymerizate containing a first polymer;
(b) removing substantially all hydrogen from the polymerizate and transferring to a second reactor; and
(c) adding ethylene, a C₄₋₈ α-olefin comonomer and hydrogen to the second reactor and continuing the polymerization to produce a bimodal polyethylene product comprised of said first polymer and a second polymer of relatively lower density and higher molecular weight than that of the first polymer.

2. The process of claim 1 wherein the weight ratio of first polymer to second polymer is from 65:35 to 40:60.

3. The process of claim 1 wherein the alkoxysilane has the formula R*_{4-y} Si (OR*)_{y} where y is 2 or 3 and R* is independently an alkyl or cycloalkyl group.

4. The process of claim 3 wherein the alkoxysilane is selected from the group consisting of cyclohexylmethyldimethoxysilane and methyltriethoxysilane and mixtures thereof.

5. The process of claim 1 wherein the α-olefin comonomer is selected from the group consisting of butene-1, hexene-1 and octene-1 and mixtures thereof.

6. The process of claim 1 wherein the polymerizations are carried out in an inert hydrocarbon.

7. The process of claim 1 wherein the alkoxysilane is cyclohexylmethyldimethoxysilane and the α-olefin comonomer is butene-1.

8. The process of claim 2 wherein the weight ratio of first polymer to second polymer is from 60:40 to 45:55.

9. The process of claim 2 wherein conditions in the first reactor are maintained to target the formation of first polymer having a density of 0.964 g/cm³ or above and MI₂ in the range 50 to 400 g/10 min and conditions in the second reactor are maintained to target a final bimodal product density of 0.946 to 0.955 g/cm³ and final bimodal product HLMI of 3 to 16 g/10 min.

10. The process of claim 9 wherein the polymerizations are carried out in an inert hydrocarbon, the alkoxysilane is cyclohexylmethyldimethoxysilane and the α-olefin comonomer is butene-1.

11-17. (canceled)
